(19) United States
(12) Patent Application Publication
(10) Pub. No.: US 2026/0311003 A1
(43) Pub. Date: Oct. 8, 2026

(54) METHODS, SYSTEMS, AND COMPUTER PROGRAM PRODUCTS FOR FEATURE ENGINEERING TO FACILITATE PROCESSING OF HETEROGENEOUS DATASETS BY A PROCESSOR

(71) Applicant: Francis Cianfrocca, Raleigh, NC (US)

(72) Inventor: Francis Cianfrocca, Raleigh, NC (US)

(21) Appl. No.: 19/634,584

(22) Filed: Mar. 31, 2026

Related U.S. Application Data
(60) Provisional application No. 63/782,221, filed on Apr. 2, 2025.

(51) Int. Cl. G06N 5/04; G06F 40/284

(52) U.S. Cl. CPC G06N 5/04; G06F 40/284

(57) ABSTRACT

A computer-implemented method includes receiving input data; and transforming the input data to generate output data that maintains relationships between individual data items of the input data, the output data including language data associated with the data items.

### CROSS-REFERENCE TO RELATED APPLICATION

The present application claims priority to U.S. Provisional Patent Application Ser. No. 63/782,221, filed Apr. 2, 2025, the entire content of which is incorporated by reference herein as if set forth in its entirety

### FIELD

The present disclosure relates generally to data processing systems, and, more particularly, to transforming data to facilitate natural language processing thereof.

### BACKGROUND

Many traditional (e.g., non-generative) artificial intelligence technologies generate predictions based on measuring statistical importance of features in view of historical data. However, the reliance on statistical operations by these machine learning technologies in some cases limits their applicability because statistical operations and output predictions are not easily explainable. Recently, generative artificial intelligence models such as Large Language Models (LLMs) or Natural Language Processing (NLP) have been developed where at least the output of such models can be easily explainable given the nature of LLMs/NLPs receiving a text prompt and outputting a text response message. Natural language processing, or NLP, is a branch of AI that helps computers understand, interpret, and generate human language, whether that language is written or spoken. It combines ideas from linguistics, machine learning, and deep learning to make text and speech useful for tasks like translation, chatbots, search, and sentiment analysis. LLM/NLP systems can break language into smaller pieces, clean and normalize text, and then analyze structure and meaning. Common tasks include tokenization, stemming or lemmatization, named entity recognition, sentiment analysis, speech recognition, summarization, and question answering.

### SUMMARY

According to some embodiments of the disclosure, a computer-implemented method, comprises: receiving input data; and transforming the input data to generate output data that maintains relationships between individual data items of the input data, the output data including language data associated with the data items.

In other embodiments, the input data is structured input data.

In still other embodiments, the input data is unstructured input data.

In still other embodiments, the input data includes natural language text.

In still other embodiments, the natural language text further includes image data.

In still other embodiments, the input data comprises heterogeneous input data.

In still other embodiments, transforming the input data comprises: associating a label with one of the data items.

In still other embodiments, transforming the input data comprises: generating a single output data item for multiple ones of the data items; generating multiple output data items for multiple ones of the data items; or generating multiple output data items for a single one of the data items.

In still other embodiments, the output data has syntactic relationships and a vocabulary associated therewith.

In still other embodiments, the language data comprises a token associated with one of the data items, the token representing a category or a numeric relationship.

In still other embodiments, the method further comprises: training a Natural Language Processing (NLP) model using the output data.

In still other embodiments, the method further comprises: operating a Natural Language Processing (NLP) model to generate an inference responsive to a prompt comprising the output data.

In still other embodiments, the method further comprises: updating a pre-trained model by performing an additional training operation using the output data.

According to some embodiments of the disclosure, a system comprises: one or more processors; and one or more memories storing process-executable instructions that, when executed by the one or more processors, cause the one or more processors to perform operations comprising: receiving input data; and transforming the input data to generate output data that maintains relationships between individual data items of the input data, the output data including language data associated with the data items.

In still further embodiments, transforming the input data comprises: generating a single output data item for multiple ones of the data items; generating multiple output data items for multiple ones of the data items; or generating multiple output data items for a single one of the data items.

In still further embodiments, the output data has syntactic relationships and a vocabulary associated therewith.

In still further embodiments, the language data comprises a token associated with one of the data items, the token representing a category or a numeric relationship.

In still further embodiments, the operations further comprise: training a Natural Language Processing (NLP) model using the output data.

In still further embodiments, the operations further comprise: operating a Natural Language Processing (NLP) model to generate an inference responsive to a prompt comprising the output data.

According to some embodiments of the disclosure, one or more non-transitory computer-readable media storing processor-executable instructions that, when executed by one or more processors, cause the one or more processors to perform operations comprising: receiving input data; and transforming the input data to generate output data that maintains relationships between individual data items of the input data, the output data including language data associated with the data items.

It is noted that aspects described with respect to one embodiment may be incorporated in different embodiments although not specifically described relative thereto. That is, all embodiments and/or features of any embodiments can be combined in any way and/or combination. Moreover, other methods, systems, articles of manufacture, and/or computer program products according to embodiments of the disclosure will be or become apparent to one with skill in the art upon review of the following drawings and detailed description. It is intended that all such additional systems, methods, articles of manufacture, and/or computer program products be included within this description, be within the scope of the present inventive subject matter and be protected by the accompanying claims.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram that illustrates a communication network including a Genomicizer, i.e., data transformation system, for transforming data to generate output data in which relationships between data items of the input data are preserved while further including language data associated with one or more of the data items according to some embodiments of the disclosure;

FIG. 2 is a block diagram illustrating the Genomicizer of FIG. 1 according to some embodiments of the disclosure;

FIG. 3 is a block diagram of a Natural Language Processing (NLP) system according to some embodiments of the disclosure;

FIG. 4 is a flowchart that illustrates operations of transforming data using a Genomicizer according to some embodiments of the disclosure;

FIG. 5 is block diagram of a data processing system that can be used to implement a system for transforming data to generate output data in which relationships between data items of the input data are preserved while further including language data associated with one or more of the data items according to some embodiments of the disclosure;

FIG. 6 is a block diagram of a predictive data analysis computing entity of FIG. 4 according to some embodiments of the disclosure; and

FIG. 7 is a block diagram of an external computing entity of FIG. 4 according to some embodiments of the disclosure.

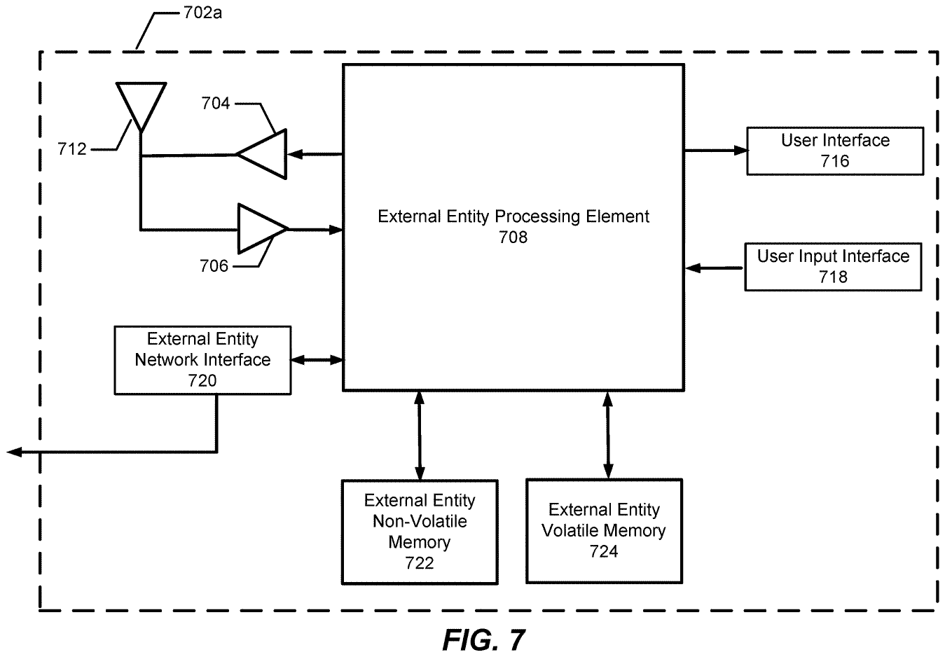

### DETAILED DESCRIPTION

In the following detailed description, numerous specific details are set forth to provide a thorough understanding of embodiments of the disclosure. However, it will be understood by those skilled in the art that embodiments of the disclosure may be practiced without these specific details. In some instances, well-known methods, procedures, components, and circuits have not been described in detail so as not to obscure the disclosure. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

Embodiments of the disclosure are described herein in the context of transforming one or more datasets into one or more data structures that are configured to be stored in a computer readable-medium. These data structures may be read using one or more processors configured, for example, to execute an Artificial Intelligence (AI) machine-learned model. The machine-learned model may be embodied in a variety of different ways including, but not limited to, one or more of the following AI systems: a multi-layer neural network, a machine learning system, a deep learning system, a large language model, a natural language processing system, and/or computer vision system. Moreover, it will be understood that the multi-layer neural network is a multi-layer artificial neural network comprising artificial neurons or nodes and does not include a biological neural network comprising real biological neurons. The machine-learned model described herein may be configured to transform a memory of a computer system to include one or more data structures, such as, but not limited to, arrays, extensible arrays, linked lists, binary trees, balanced trees, heaps, stacks, and/or queues. These data structures can be configured or modified through the adjudication process and/or the AI training process to improve the efficiency of a computer system when the computer system operates in an inference mode to make an inference, prediction, classification, suggestion, or the like.

According to some embodiments of the disclosure, the features used during the training of the machine-learned model may be evaluated and one or more of the features with a lesser relative impact on an output when operating in inference mode, e.g., an inference, prediction, classification, suggestion, or the like, may be removed as part of a model sparsification process during both training and inference mode to sparsify the machine-learned model. When the machine-learned model comprises a neural network, one or more nodes or paths may be removed (e.g., through setting certain parameters or weights to zero) based on the elimination of one or more features. Advantageously, sparsification of the machine-learned model may allow the model to execute using less memory and reduced computational requirements.

Advantageously, one or more of the features used in training or during inference mode of the machine-learned model may be selected to have different quantization levels, e.g., 64-bit, 32-bit, etc. to reduce the size and complexity of the machine-learned model. For example, the quantization level for representing the various features may be varied based on a level of precision required in distinguishing between features.

Embodiments of the disclosure may provide a general method for converting various datasets into any derivative data structure, which has one or more features of natural (human) languages. The data structures generated according to embodiments of the disclosure are well suited for further processing using artificial intelligence methods that are designed to process natural languages where the original input data may be unsuitable as a prompt for a natural language processing system.

Embodiments of the disclosure may be referred to as “Genomic AI.” Similarly, we will also refer to several components of the disclosure using names inspired by genetics. However, note that all of these terms are used metaphorically. Embodiments of the disclosure may be applied generally and are not restricted to the science of genetics.

Embodiments of the disclosure may provide a method for processing datasets to reduce them to forms, which embody the content and meaning of the original data, but are expressed using forms that are identical or analogous to the forms of natural or human language. These forms, in turn, may easily be processed by the plethora of recent AI methods for processing natural language.

Embodiments of the disclosure may be configured to adapt datasets (which lack inherent linguistic features such as syntax and grammatic rules) for use by technologies (such as LLMs and sentence transformers) that depend on the presence of these features.

Embodiments of the disclosure may provide datasets with a structure, presentation, storage that radically differs from the structure, presentation, and storage of texts written in natural languages.

Embodiments of the disclosure may unify the realm of bulk datasets (which usually originate in natural, artificial, or industrial processes) with the world of human speech and writing. An advantage of this unification is that it may extend to general data the benefits and the emergent capabilities of language-processing AI.

Genomic AI, according to some embodiments, can process structured datasets of any type, size, or origin. Examples include, but are not limited to, telemetry from industrial processes, financial data, customer/market data, scientific data (such as seismology and weather data, and data from physics experiments), and telemetry from physical security systems.

Genomic AI, according to some embodiments, can process unstructured datasets of any type, size, or origin. Examples include, but are not limited to, data in self-describing formats (such as JSON or XML).

Genomic AI, according to some embodiments, can process datasets consisting of natural-language texts, with or without “labels.”

Genomic AI, according to some embodiments, can process multimodal datasets containing combinations of natural-language text and images, with or without “labels.”

Genomic AI, according to some embodiments, can process any number of heterogeneous datasets in combination. This aspect of the disclosure may be advantageous because heterogeneous datasets suffer from a lack of ontological unity, making it difficult or impossible to analyze them in combination. Transformation by Genomic AI may add this unity and enables “meta-analysis” of very large composite datasets.

Some embodiments of Genomic AI add meaningful “labels” to the individual items in a dataset, greatly increasing the value of the resulting genomic data for purposes such as prediction and anomaly detection.

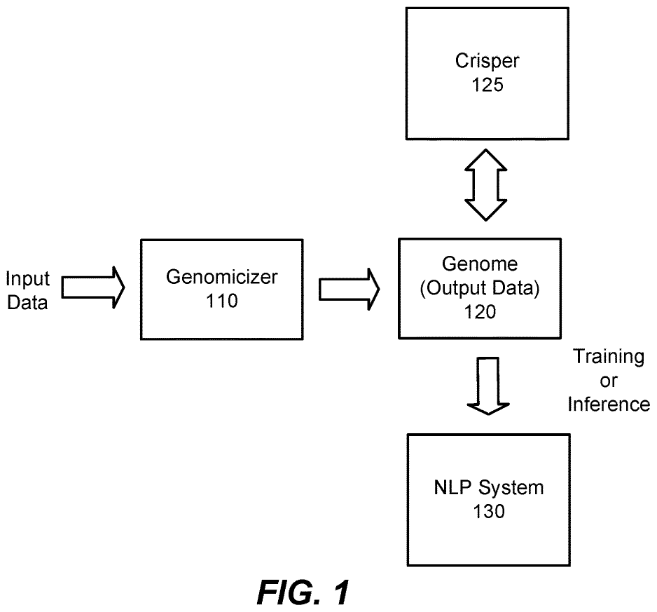

Referring to FIG. 1. A communication network includes a Genomicizer 110, a Genome 120, a Crisper 125, and a Natural Language Processing (NLP) system 130. The Genomicizer 110 is configured to receive input data and transform the input data to generate output data that maintains the relationships between the individual data items of the input data while further including language data associated with the data items. In this way, the Genomicizer can generate output data that can be processed using AI systems, such as NLP systems, that are configured to receive natural language prompts as input. The raw input data prior to being transformed by the Genomicizer 110 may be in a form that is not suitable for processing using an NLP system as it may numeric or of a form that is not recognizable by ab NLP system. Thus, the input data may be structured input data, unstructured input data, and/or may include natural language text. When the input data includes natural language text, the Genomicizer 110 may generate output data 120 that includes additional language data that is configured to be processed by an NLP system. In some embodiments, the natural language text in the raw input data may include one or more images. Thus, in some embodiments, the NLP system may process raw natural language in the input data as well as supplemented language data provided by the Genomicizer 110. In some embodiments, the input data may comprise heterogenous input data that are for example associated with different applications and/or are of different types of data, e.g., text, image, video, and the like. Moreover, the output data 120 generated by the Genomicizer 110 may comprise heterogenous data due to the addition of the language data associated with the individual data items of the input data. As shown in FIG. 1, the output data 120 may be considered a Genome 120 with individual portions of the output data being considered Genes of the Genome 120. The output data 120 may be received by an NLP system 130 and used for training the NLP system 130 or the NLP system 130 may use the output data 120 as input when operating in inference mode. In some embodiments, the output data may be processed by a Crisper 125. The Crisper 125 contains pretrained models based on the same language associated with the output data 120, which may be associated with a particular application, such as an application associated with a particular entity. The Crisper 125 can use the output data 120 from the Genomicizer 110 to train the pre-trained models associated with this language and update these trained models so that the models evolve over time based on new output data 120.

Embodiments of the Genomicization process are described in additional detail hereafter:

In Genomic AI, according to some embodiments, a dataset is processed item by item by a “Genomicizer 110” to produce a “Genome” consisting of “Genes.” The genomicizer may operate in bulk on a dataset stored in a self-contained body of data (batch mode), or it may operate continuously on datasets that are continuously generated in real time (streaming mode). The original dataset may be stored or discarded after processing by the genomicizer.

The Genomicizer 110 may consist of any combination of methods including algorithmic (traditional) software, supervised AI methods (for example, deep learning models), or unsupervised (self-learning) AI methods (for example, pretrained transformers). After the Genomicizer 110 completes its processing of a dataset, the result is a “Genome 120.” A genome 120 is a set of “Genes,” derived from the contents of the original dataset. The genomicizer may also add any additional information or data (“Gene Labels”) derived from any source during processing.

Some embodiments of the Genomicizer 110 generates a single gene for each item or row of the original dataset. Other embodiments group multiple items into a single gene. Still other embodiments perform a meta-analysis (for example, a temporal aggregation) across multiple input rows to produce synthesized genes embodying additional knowledge about the data.

According to some embodiments, the genomicization is that the Genes it produces have the structure and format of sentences in a natural (human) language, which structure was either obscured or not present at all in the original data. Embodiments of the disclosure can use any software methods at all to analyze the incoming dataset to produce Genes with appropriate linguistic features (for example, syntax rules, parts of speech, and vocabulary) for any given application.

In particular, Genomicizers 110 may be customized for specific datasets, and/or specific business/technical practice areas, and/or specific organizations. As such, they may be created by subject matter experts in any or all of these separate categories. By this method, ontology and semantic meaning may be added to the Genes in the Genome 120 by encoding it within the linguistic structures introduced by the Genomicizer 110.

The Genomes 120 produced by an embodiment of the disclosure are thus derived from the original data, but they have been enriched with linguistic features that encode the semantics and ontology of the data. As such, the Genomes 120 may be directly processed using any language-based AI (including LLMs and sentence transformers) to “discover” the semantics and ontology encoded in the Genome 120. Genomicizers 110 may also be constructed without encoding any domain-specific knowledge, instead using the methods of so-called Artificial General Intelligence (AGI).

According to some embodiments, Genes have the structure and format of sentences in a natural (human) language, even though the actual language of the Genes is not necessarily an existing natural language (although it may be an existing language, or a combination of an existing language with additional language elements such as syntactic elements or vocabulary).

Example features of a Gene may include, but are not limited to the following: a well-defined but extensible vocabulary; parts of speech (functional descriptions of vocabulary words within the grammar, such as nouns, verbs, adjectives, prepositions, etc.; and a defined set of rules for constructing genes based on word order (syntax or grammar). The language so described is called a Species. Any Genome 120 may have a Species, whether or not this is well-defined or known. A Species is in effect a language definition that is adapted to a particular dataset, business/technical domain, or organization, or any combination thereof.

In some embodiments, the Species is used to construct the Genomicizer 110 (which is a software artifact). In other embodiments, a Genomicizer 110 can be written to create Genomes 120 without a pre-defined Species.

According to some embodiments, methods may be constructed for discovering the Species of a particular dataset once the data have been passed through a Genomicizer 110. In other words, the Genomicizer 110 may, in some embodiments, use predetermined (algorithmic or supervised-AI) methods to generate Genes.

According to some embodiments, the genomicization process incorporates a number of specific innovations, which incorporate the semantics and ontology of datasets in ways that are not needed when using AI to process human-written text.

An example of these relates to numeric quantities, which encode meaning through their placement within an ordered space (i.e., numbers are meaningful in datasets because they can be compared to each other).

But unlike vocabulary words in a human language, numeric quantities are unlimited. To address this, embodiments of the disclosure may categorize numeric quantities into a well-defined set of ranges, expressed by vocabulary words or tokens, which are distinctly associated with each Species. For example, measurements of network traffic can be expressed with vocabulary words or tokens that each represent the natural logarithm of a range of values.

In this way, according to some embodiments, the “orderedness” of numeric values can be trained into a language model using conventional techniques (deep learning), thus encoding in a linguistic structure knowledge that is not inherently linguistic in nature.

Embodiments of the disclosure may incorporate a “fuzzing” method into the construction of Species. A very large number of sample Genomes 120 may be constructed synthetically by a computer, embodying random variations of particular words or sentence structure chosen on a probabilistic model. These “fuzzing sets” are used to pretrain the language-based AIs (LLMs, sentence transformers, etc.) which will subsequently process Genomes 120 derived from real data. This can substantially enhance the accuracy of the behavioral models encoded within the Genomes 120.

In this embodiment of the disclosure, the Genomes 120 are transmitted continuously to a Genome Analyzer (which may be called the “Crisper 125”). The Crisper 125 contains pretrained models developed with Genomes 120 of the same Species, both from the specific organization being described, and from earlier ones developed in other organizations. The Crisper 125 performs two separate actions with each new Genome 120 that it receives: first, it compares the incoming Genome 120 to its pretrained models for this Species, looking for variations; and second, it adds the new Genome 120 to the training set for evolving the training of the models themselves. In this way, the Crisper 125 is able to detect sudden behavioral shifts which often predict operational failure or malicious activity; and it is also able to respond to shifts in normal behavior over time.

By feeding these continuously produced Genomes 120 into appropriately-trained AI tools (for example, sentence transformers or LLMs), a behavioral baseline may automatically emerge inside the AI. According to some embodiments, the capabilities of the AI may be used (for example, a Sentence Transformer or LLM) to discover subtle behavioral patterns, which are beyond the ability of humans to detect.

Examples of these patterns include the specific mixture of different traffic types and sizes at particular times of day, or when particular projects are ongoing, or when the personnel in a location change.

Changes in these patterns may be exceptionally predictive of cyber threat activity (such as attempts to install malware or ransomware, or theft of intellectual property). And yet they are extremely difficult for human operators to discover, particularly at the scale of any large organization.

When tiny changes in behavior occur (for example, due to operational problems such as imminent machine failures or malicious activity by stealthy attackers), the Genomes 120 that are generated at those moments in time will reflect the subtle shifts in behavior. The appropriately-trained AI which interprets the Genomes 120 will detect the shifts using familiar linguistic techniques like sentiment analysis and cosine similarity, and immediately alert operators to the threat.

Without Genomic AI, such predictive behavioral shifts are so subtle and/or fleeting that they generally go unnoticed. Genomic AI provides a path to continuously monitor them in a highly cost-effective and manageable way.

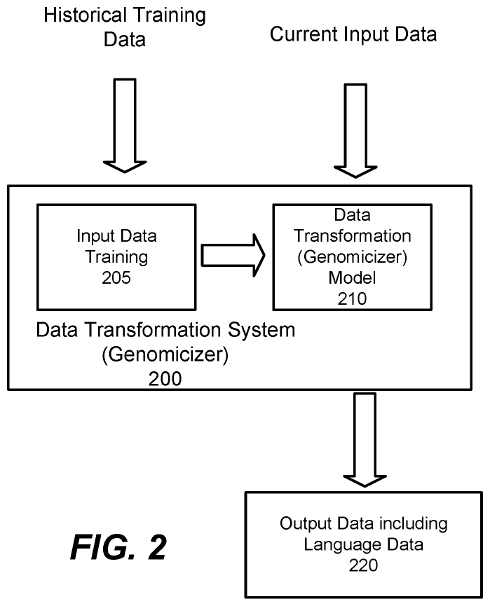

FIG. 2 is a block diagram illustrating the Genomicizer 110 of FIG. 1 according to some embodiments of the disclosure. The Genomicizer can be embodied in a variety of ways including, but not limited to, a hardware based implementation and/or a software based implementation, including implementations that have both hardware and software aspects. The software implementations can include, but are not limited to, procedural software implementations, object-oriented software implementations, firmware implementations, and AI implementations. In the example embodiment of FIG. 2, the Genomicizer 110 is implemented as an AI system including one or more machine-learned models. Referring to FIG. 2, the Genomicizer 200 may be implemented as a data transformation system 200 including an input data training module 205 and a data transformation (genomicizer) model 210.

The input data training module 205 may be configured to receive historical training data. During training, the input data training module 205 may learn associations between features of the content contained in the historical training data information. Once the input data training module 205 is trained, a data transformation model 210 may be generated to operate in inference mode and may process new or current input data. The data transformation model 210 may be configured to receive the current input data and output a Genome 120 including output data having language data incorporated therewith. The input data training module 205 may include a featuring functionality to identify the individual independent variables that are used by the data transformation model 210, which may be considered a dependent variable. For example, the historical training data may be generally unprocessed or formatted and include extra information. The features extracted from the historical training data may be called attributes and the number of features may be called the dimension. As described above, the dimension may be reduced to improve the performance of the data transformation system 200. Labeling may be performed to assign defined labels to the historical training data and to the generated predictions to ensure a consistent naming convention for both the input features and the predicted outputs. The input data training module 205 may process both the featured training data, including the labels, and may be configured to test numerous functions to establish a quantitative relationship between the featured and labeled input data and the predicted outputs. The input data training module 205 may use modeling techniques to evaluate the effects of various input data features on the predicted outputs. These effects may then be used to tune and refine the quantitative relationship between the featured and labeled input data and the predicted outputs. The tuned and refined quantitative relationship between the featured and labeled input data generated by the input data training module 205 is output for use in the data transformation model 210.

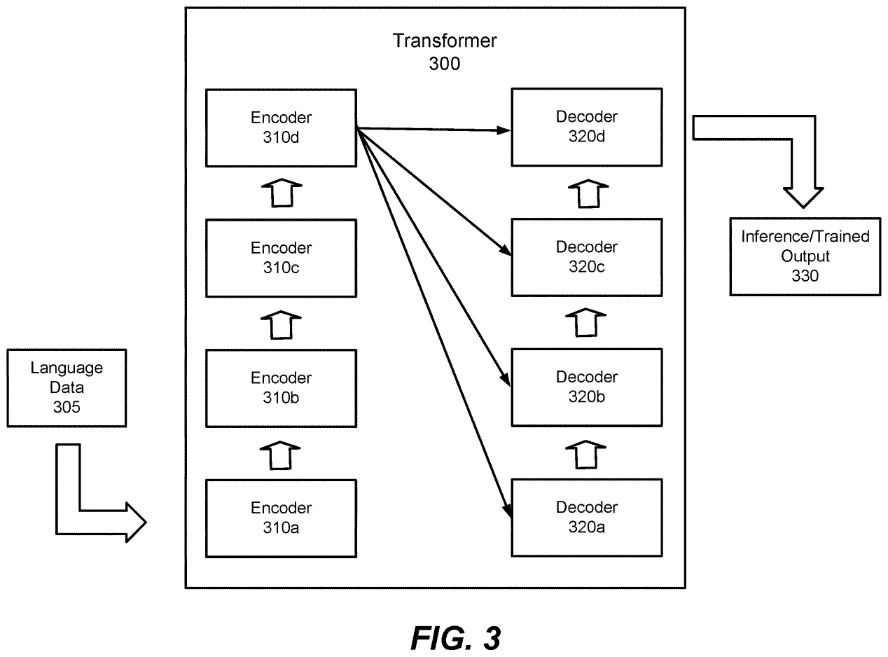

As described above with respect to FIG. 1, the Genome or output data 120 may be used as input to an NLP system 130 for training or inference. FIG. 3 is a block diagram of a Natural Language Processing (NLP) system according to some embodiments of the disclosure.

A language model is a type of machine learning model that is trained to conduct a probability distribution over words. Language models may include, for example, statistical models and those based on deep neural networks, e.g., neural language models. Statistical language models are a type of model that use statistical patterns in the data to make predictions about the likelihood of specific sequences of words. One approach to building a probabilistic language model is to calculate n-gram probabilities. An n-gram is a sequence of words, where n is a number greater than zero. To make a simple probabilistic language model, the likelihood of different n-grams, i.e., word combinations, in a portion of text is calculated. This may be done by counting the number of times each word combination appears and dividing it by the number of times the previous word appears. This approach is based on a concept called Markov assumption, which says that the probability of the next word in a sequence depends only on a fixed size window of previous words.

Neural language models predict the likelihood of a sequence of words using a neural network model. Neural language models may capture context better than traditional statistical models. Neural language models may also handle more complex language structure and longer dependencies between words. The neural network model may be trained using a large training set of text data and are generally capable of learning the underlying structure of the language. Recurrent Neural Networks (RNNs) are a type of neural network that can memorize the previous outputs when receiving the next inputs. This is in contrast to traditional neural networks, where inputs and outputs are independent of each other. RNNs may be particularly useful when it is necessary to predict the next word in a sentence, as they can take into account the previous words in the sentence. RNNs, however, can be computationally expensive and may not scale well to very long input sequences.

A large language model is a language model that is characterized by its large size, which is enabled by AI hardware accelerators allowing the model to process vast amounts of data. A large language model may be based on a neural network, which can contain a large number of weights and may be pre-trained using self-supervised and/or semi-supervised learning. In some embodiments, the large language model may be based on a transformer architecture. FIG. 3 is a block diagram of a large language model in accordance with embodiments of the disclosure, which is based on a transformer 300 architecture. The transformer name is based on the ability of the architecture to transform one sequence into another. Moreover, the transformer architecture provides for the ability to process an entire word sequence at once as opposed to one step at a time, such as is one in RNNs. This parallelization allows large language models based on a transformer architecture to be faster to train and operate in inference mode thereby improving the performance of a computer system. As shown in FIG. 3, the large language model uses an encoder-decoder architecture. An encoder stack 310a, . . . , 310d may receive a sequence of input language data 305 and convert this information into vectors, which represent the semantics and position of the words in the sentences. The decoder stack 320a, . . . , 320d may receive this vector embedding of the prompt(s) and language data 305 and use them to generate context and product the input-output mappings and the inference/trained output 330. In some embodiments, both the encoder and decoder include a stack of identical layers 310a, . . . , 310d and 320a, . . . , 320d, respectively, each containing a self-attention mechanism and a feed-forward neural network. The attention mechanism may allow the large language model 300 to focus on specific parts of the prompt(s) and language data 305 when making predictions. Specifically, the transformer 300 may calculate a weight for each element of the input, which indicates the importance of that element for the current prediction. These weights may then then used to calculate a weighted sum of the input, which is used to generate the prediction. Self-attention is a specific type of attention mechanism where the large language model 300 focuses on different parts of the input sequence to make a prediction. In such embodiments, the healthcare care service request adjudication large language model transformer 300 looks at the input sequence multiple times while focusing on a different part of the input sequence each time it looks at it. The transformer architecture may allow the self-attention mechanism to be applied multiple times in parallel, which may allow the large language model transformer 300 to learn more complex relationships between the prompts and language data 305 and the inference/trained output 330.

The large language model transformer 300 may be trained using semi-supervised learning in some embodiments of the disclosure. The large language model transformer 300 may be pre-trained using a large dataset of unlabeled data in an unsupervised training operation. The initial pre-training may allow the large language model transformer 300 to learn general patterns and relationships in the language. A second supervised training operation may then be performed in which the model may be trained using a smaller labeled dataset, such as, for example, language data 305 with various entities. This second supervised training operation may improve the performance of the large language model transformer 300 for specific applications.

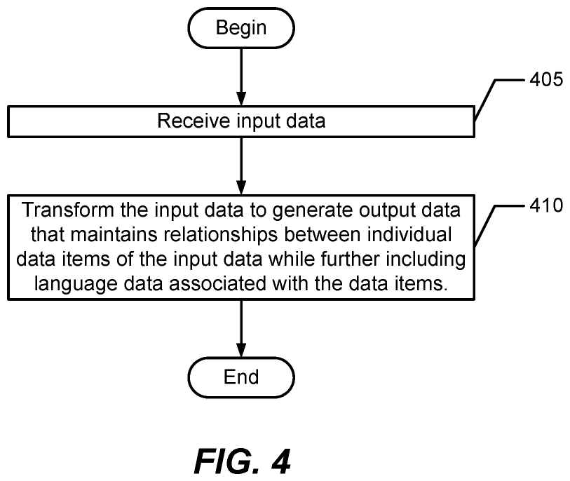

FIG. 4 is a flowchart that illustrates operations of transforming data using a Genomicizer 110 according to some embodiments of the disclosure. Operations begin at block 405 where the Genomicizer 110 receives input data. The Genomicizer 110 transforms the input data to generate output data that maintains the relationships between individual data items of the input data while further including language data associated with the data items at block 410.

Embodiments of the disclosure for transforming input data to generate output data in which the relationships between individual data items of the input data are maintained while further including language data that are associated with one or more of the data items may be illustrated by way of example.

An embodiment of the disclosure can be used in the detection of cybersecurity threats in computer networks. Such threats may be extremely difficult to detect in large, dispersed networks because the attackers are adept at hiding their presence for long periods of time.

Most organizations continuously collect very large datasets consisting of metadata from their networking operations, but have hitherto struggled to leverage these datasets to discover cyberthreats proactively and in real time.

Genomic AI provides novel tools for obtaining useful threat information from these datasets.

Consider that in threat detection, the path may be twofold: first, to accurately discover what is “normal” for a given network space; and second, to accurately detect behaviors which depart from normal in ways that betray the presence of attackers.

A Genomicizer 110, according to some embodiments, can be constructed, which generates Genomes consisting of Genes that are based on aggregated observations of the “Ethernet Protocol Number” contained in every network data packet. In this case, the Species of the generated Genomes can be very reminiscent of natural English, although with some special keywords as shown in the following example:

In the Kansas City production plant, network B16 had <ln5> <dec6> <etyip4> frames, <ln2> <dec3> <etyip6> frames, <ln3> <dec2> <etyarp> frames, and <ln1> <dec1> frames of unknown type <etya0a0>, during the 60 seconds ending at <unx1743501000>.

This Gene is created by the Genomicizer from in situ analysis of the packet headers of all the traffic traversing a network, obtained via a conventional network tap or other sensor. Observe that the Gene captures in language the amounts and proportions of different types of network traffic at the Ethernet level, such as IPv4, IPv6, ARP, and an unknown protocol which may be malicious.

According to some embodiments, the Genomes created in this way for a specific organization can be used for fine-tuning a language based model using techniques such as LoRA or RAG

Some embodiments of the disclosure may provide a linguistic technique that appears in the example Gene above: the use of custom “tokens” to capture numeric relationships among quantities, categoric representations such as network protocols, and generally anything with a numeric scale. In the sample Gene above, These tokens are all of the “words” defined in the Species that appear inside angle brackets: among them, <etyip4>, <etyarp>, <unx1743501000>, <ln1>, <dec1>, and numerous others.

These custom tokens, according to some embodiments of the inventive concept, may be used to address a persistent weakness of LLMs and other language-oriented AIs: their inability to accurately model numeric relationships.

Because of the syntactic equivalence of natural-language words which stand for different quantities, LLMs and sentence transformers may struggle to capture the quality of the relationships. This may be a manageable problem in text generation and other language-based applications, but it may be a more difficult problem when processing data.

The Species defines values like “60 percent” as <pct60> or <dec6> (“decile 6); or a large number as a natural logarithm indicated by <ln10>, or an ethernet protocol number like 0x800 as <etyip4>. This has the effect of situating real and complex numbers into a low-cardinality space denoted by token words within the Species.

AI systems like sentence transformers and LLMs can be trained to learn the scalar relationships among the various token words in this Species. In this way, they are able to learn, describe and compare behaviors of processes that are latent in the original data.

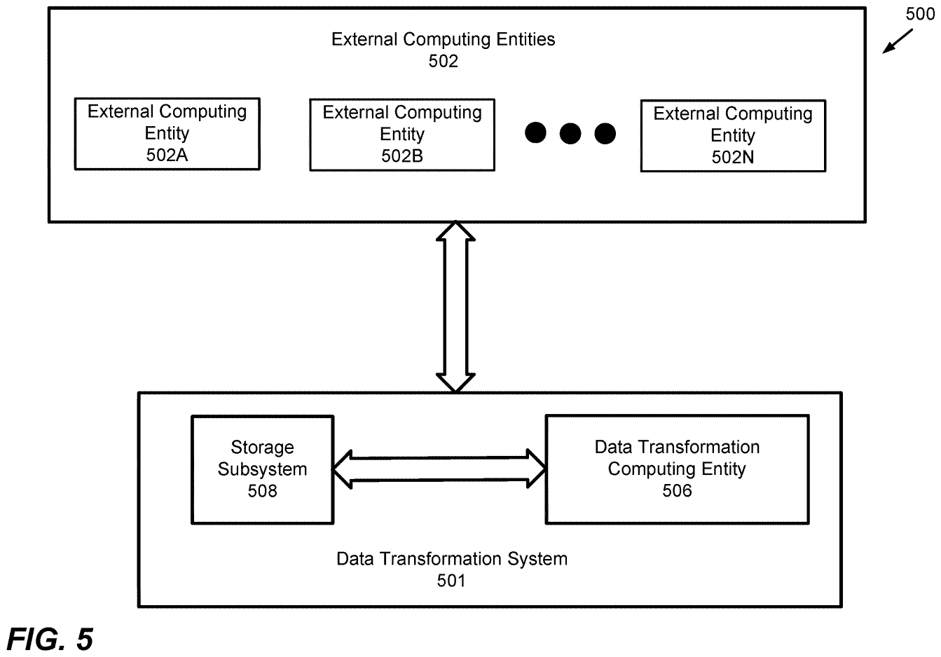

FIG. 5 provides an example overview of a system 500 that can be used to practice embodiments of the present disclosure. The system 500 includes a data transformation system 501 comprising a data transformation computing entity 506 configured to generate outputs that can be used to perform one or more output-based actions. The system 500 may be used to implement one or more of the functional blocks described above with respect to FIG. 1-4. The data transformation system 501 may communicate with one or more external computing entities 502A-N using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (e.g., network routers, and/or the like).

The system 500 includes a storage subsystem 508 configured to store at least a portion of the data utilized by the data transformation system 501. The data transformation computing entity 506 may be in communication with the external computing entities 502A-N. The data transformation computing entity 506 may be configured to: (i) train one or more machine learning models based on a training data store stored in the storage subsystem 508, (ii) store trained machine learning models as part of a model definition data store of the storage subsystem 508, (iii) use trained machine learning models to perform an action, and/or the like.

In one example, the data transformation computing entity 506 may be configured to generate a prediction, classification, and/or any other data insight based on data provided by an external computing entity such as external computing entity 502A, external computing entity 502B, and/or the like.

The storage subsystem 508 may be configured to store the model definition data store and the training data store for one or more machine learning models. The data transformation computing entity 506 may be configured to receive requests and/or data from at least one of the external computing entities 502A-N, process the requests and/or data to generate outputs (e.g., predictive outputs, classification outputs, and/or the like), and provide the outputs to at least one of the external computing entities 502A-N. In some embodiments, the external computing entity 502A, for example, may periodically update/provide raw and/or processed input data to the data transformation system 501. The external computing entities 502A-N may further generate user interface data (e.g., one or more data objects) corresponding to the outputs and may provide (e.g., transmit, send, and/or the like) the user interface data corresponding with the outputs for presentation to the external computing entity 502A (e.g., to an end-user).

The storage subsystem 508 may be configured to store at least a portion of the data utilized by the data transformation computing entity 506 to perform one or more operations/operations and/or tasks described herein. The storage subsystem 508 may be configured to store at least a portion of operational data and/or operational configuration data including operational instructions and parameters utilized by the data transformation computing entity 506 to perform the one or more operations/operations described herein. The storage subsystem 508 may include one or more storage units, such as multiple distributed storage units that are connected through a computer network. Each storage unit in the storage subsystem 508 may store at least one of one or more data assets and/or one or more data about the computed properties of one or more data assets. Moreover, each storage unit in the storage subsystem 108 may include one or more non-volatile storage or memory media including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

The data transformation computing entity 506 can include an analysis engine and/or a training engine. The predictive analysis engine may be configured to perform one or more data analysis techniques. The training engine may be configured to train the predictive analysis engine in accordance with the training data store stored in the storage subsystem 108.

FIG. 5 provides an example predictive data analysis computing entity 606 in accordance with some embodiments discussed herein. In general, the terms computing entity, computer, entity, device, system, and/or similar words used herein interchangeably may refer to, for example, one or more computers, computing entities, desktops, mobile phones, tablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations/operations, and/or processes described herein. Such functions, operations/operations, and/or processes may include, for example, transmitting, receiving, operating on, processing, displaying, storing, determining, creating/generating, monitoring, evaluating, comparing, and/or similar terms used herein interchangeably. In one embodiment, these functions, operations/operations, and/or processes can be performed on data, content, information, and/or similar terms used herein interchangeably.

The predictive data analysis computing entity 606 may include a network interface 608 for communicating with various computing entities, such as by communicating data, content, information, and/or similar terms used herein interchangeably that can be transmitted, received, operated on, processed, displayed, stored, and/or the like.

In one embodiment, the predictive data analysis computing entity 606 may include or be in communication with a processing element 602 (also referred to as processors, processing circuitry, and/or similar terms used herein interchangeably) that communicate with other elements within the predictive data analysis computing entity 606 via a bus, for example. As will be understood, the processing element 602 may be embodied in a number of different ways including, for example, as at least one processor/processing apparatus, one or more processors/processing apparatuses, and/or the like.

For example, the processing element 602 may be embodied as one or more complex programmable logic devices (CPLDs), microprocessors, multi-core processors, coprocessing entities, application-specific instruction-set processors (ASIPs), microcontrollers, and/or controllers. Further, the processing element 602 may be embodied as one or more other processing devices or circuitry. The term circuitry may refer to an entirely hardware embodiment or a combination of hardware and computer program products. Thus, the processing element 602 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 602 may be configured for a particular use or configured to execute instructions stored in one or more memory elements including, for example, one or more volatile memories 604 and/or non-volatile memories 610. As such, whether configured by hardware or computer program products, or by a combination thereof, the processing element 602 may be capable of performing operations or operations according to embodiments of the present disclosure when configured accordingly. The processing element 602, for example in combination with the one or more volatile memories 604 and/or or non-volatile memories 610, may be capable of implementing one or more computer-implemented methods described herein. In some implementations, the predictive data analysis computing entity 606 can include a computing apparatus, the processing element 602 can include at least one processor of the computing apparatus, and the one or more volatile memories 604 and/or non-volatile memories 610 can include at least one memory including program code. The at least one memory and the program code can be configured to, upon execution by the at least one processor, cause the computing apparatus to perform one or more operations/operations described herein.

The non-volatile memories 604 (also referred to as non-volatile storage, memory, memory storage, memory circuitry, media, and/or similar terms used herein interchangeably) may include at least one non-volatile memorydevice 204, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile memories 610 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

The one or more volatile memories (also referred to as volatile storage, memory, memory storage, memory circuitry, media, and/or similar terms used herein interchangeably) can include at least one volatile memory 604 device, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile memories 604 may be used to store at least portions of the databases, database instances, database management systems, data, applications, programs, program modules, scripts, source code, object code, byte code, compiled code, interpreted code, machine code, executable instructions, and/or the like being executed by, for example, the processing element 602. Thus, the databases, database instances, database management systems, data, applications, programs, program modules, scripts, source code, object code, byte code, compiled code, interpreted code, machine code, executable instructions, and/or the like may be used to control certain embodiments of the operation of the predictive data analysis computing entity 106 with the assistance of the processing element 602.

As indicated, in one embodiment, the predictive data analysis computing entity 606 may also include the network interface 608 for communicating with various computing entities, such as by communicating data, content, information, and/or the like that can be transmitted, received, operated on, processed, displayed, stored, and/or the like. Such communication data may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 106 may be configured to communicate via wireless client communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

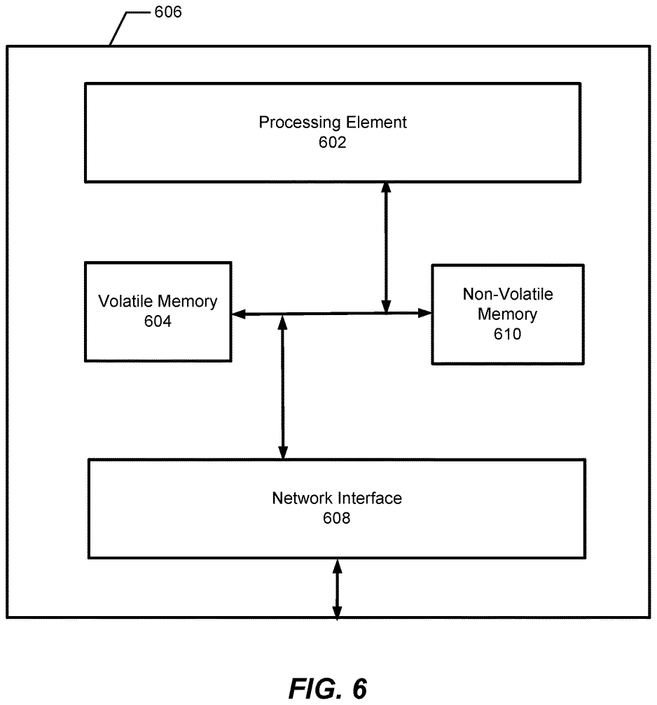

FIG. 6 provides an example external computing entity 702a in accordance with some embodiments discussed herein. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations/operations, and/or processes described herein. The external computing entities 702a-N (corresponding to external computing entities 502A-N can be operated by various parties. As shown in FIG. 6, the external computing entity 702a can include an antenna 712, a transmitter 704 (e.g., radio), a receiver 706 (e.g., radio), and/or an external entity processing element 708 (e.g., CPLDs, microprocessors, multi-core processors, coprocessing entities, ASIPs, microcontrollers, and/or controllers) that provides signals to and receives signals from the transmitter 704 and the receiver 706, correspondingly. As will be understood, the external entity processing element 708 may be embodied in a number of different ways including, for example, as at least one processor/processing apparatus, one or more processors/processing apparatuses, and/or the like as described herein with reference the processing element 602.

The signals provided to and received from the transmitter 704 and the receiver 706, correspondingly, may include signaling information/data in accordance with air interface standards of applicable wireless systems. In this regard, the external computing entity 702a may be capable of operating with one or more air interface standards, communication protocols, modulation types, and access types. More particularly, the external computing entity 702a may operate in accordance with any of a number of wireless communication standards and protocols, such as those described above with regard to the data transformation computing entity 506. In a particular embodiment, the external computing entity 702a may operate in accordance with multiple wireless communication standards and protocols, such as UMTS, CDMA2000, 1xRTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the external computing entity 702a may operate in accordance with multiple wired communication standards and protocols, such as those described above with regard to the data transformation computing entity 506 via an external entity network interface 720.

Via these communication standards and protocols, the external computing entity 702a can communicate with various other entities using means such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 102A can also download changes, add-ons, and updates, for instance, to its firmware, software (e.g., including executable instructions, applications, program modules), operating system, and/or the like.

According to some embodiments of the disclosure, the external computing entity 702a may include location determining embodiments, devices, modules, functionalities, and/or the like. For example, the external computing entity 702a may include outdoor positioning embodiments, such as a location module adapted to acquire, for example, latitude, longitude, altitude, geocode, course, direction, heading, speed, universal time (UTC), date, and/or various other information/data. In one embodiment, the location module can acquire data such as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating a position of the external computing entity 702a in connection with a variety of other systems, including cellular towers, Wi-Fi access points, and/or the like. Similarly, the external computing entity 702a may include indoor positioning embodiments, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning embodiments can be used in a variety of settings to determine the location of someone or something to within inches or centimeters.

The external computing entity 702a may include a user interface 716 (e.g., a display, speaker, and/or the like) that can be coupled to the external entity processing element 708. In addition, or alternatively, the external computing entity 702a can include a user input interface 718 (e.g., keypad, touch screen, microphone, and/or the like) coupled to the external entity processing element 708).

For example, the user interface 716 may be a user application, browser, and/or similar words used herein interchangeably executing on and/or accessible via the external computing entity 702a to interact with and/or cause the display, announcement, and/or the like of information/data to a user. The user input interface 718 can comprise any of a number of input devices or interfaces allowing the external computing entity 702a to receive data including, as examples, a keypad (hard or soft), a touch display, voice/speech interfaces, motion interfaces, and/or any other input device. In embodiments including a keypad, the keypad can include (or cause display of) the conventional numeric (0-9) and related keys (#, *, and/or the like), and other keys used for operating the external computing entity 702a and may include a full set of alphabetic keys or set of keys that may be activated to provide a full set of alphanumeric keys. In addition to providing input, the user input interface 718 can be used, for example, to activate or deactivate certain functions, such as screen savers, sleep modes, and/or the like.

The external computing entity 702a can also include one or more external entity non-volatile memories 722 and/or one or more external entity volatile memories 724, which can be embedded within and/or may be removable from the external computing entity 702a. As will be understood, the external entity non-volatile memories 722 and/or the external entity volatile memories 724 may be embodied in a number of different ways including, for example, as described herein with reference the volatile memory 604 and/or the non-volatile memory 610.

Some embodiments of the disclosure may provide methods, systems, and computer program products that transform input data to generate output data in which the relationships between individual data items of the input data are maintained while further including language data that are associated with one or more of the data items. as set forth in the following examples:

Example 1: a computer-implemented method, comprises: receiving input data; and transforming the input data to generate output data that maintains relationships between individual data items of the input data, the output data including language data associated with the data items.

Example 2: the computer-implemented method of Example 1, wherein the input data is structured input data.

Example 3: the computer-implemented method of Example 1, wherein the input data is unstructured input data.

Example 4: the computer-implemented method of any of Examples 1-3, wherein the input data includes natural language text.

Example 5: the computer-implemented method of Example 4, wherein the natural language text further includes image data.

Example 6: the computer-implemented method of any of Examples 1-5, wherein the input data comprises heterogeneous input data.

Example 7: the computer-implemented method of any of Examples 1-6, wherein transforming the input data comprises: associating a label with one of the data items.

Example 8: the computer-implemented method of any of Examples 1-7, wherein transforming the input data comprises: generating a single output data item for multiple ones of the data items; generating multiple output data items for multiple ones of the data items; or generating multiple output data items for a single one of the data items.

Example 9: the computer-implemented method of any of Examples 1-8, wherein the output data has syntactic relationships and a vocabulary associated therewith.

Example 10, the computer-implemented method of any of Examples 1-9, wherein the language data comprises a token associated with one of the data items, the token representing a category or a numeric relationship.

Example 11: the computer-implemented method of any of Examples 1-10, wherein the method further comprises: training a Natural Language Processing (NLP) model using the output data.

Example 12, the computer-implemented method of Example 1, the computer-implemented method of any of Examples 1-11, wherein the method further comprises: operating a Natural Language Processing (NLP) model to generate an inference responsive to a prompt comprising the output data.

Example 13, the computer-implemented method of any of Examples 1-12, wherein the method further comprises: updating a pre-trained model by performing an additional training operation using the output data.

Example 14: a system, comprises: one or more processors; and one or more memories storing process-executable instructions that, when executed by the one or more processors, cause the one or more processors to perform operations comprising: receiving input data; and transforming the input data to generate output data that maintains relationships between individual data items of the input data, the output data including language data associated with the data items.

Example 15: the system of any of Examples 13-14, wherein transforming the input data comprises: generating a single output data item for multiple ones of the data items; generating multiple output data items for multiple ones of the data items; or generating multiple output data items for a single one of the data items.

Example 16: the system of any of Examples 14-15, wherein the output data has syntactic relationships and a vocabulary associated therewith.

Example 17: the system of any of Examples 14-16, wherein the language data comprises a token associated with one of the data items, the token representing a category or a numeric relationship.

Example 18: the system of any of Examples 14-17, wherein the operations further comprise: training a Natural Language Processing (NLP) model using the output data.

Example 19: the system of any of Examples 14-18, wherein the operations further comprise: operating a Natural Language Processing (NLP) model to generate an inference responsive to a prompt comprising the output data.

Example 20, one or more non-transitory computer-readable media storing processor-executable instructions that, when executed by one or more processors, cause the one or more processors to perform operations comprising: receiving input data; and transforming the input data to generate output data that maintains relationships between individual data items of the input data, the output data including language data associated with the data items.

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components include a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These include physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is included in at least one embodiment, but not every embodiment necessarily includes the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not include other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may include a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters(e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may include a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may include any type of model configured, trained, and/or the like to generate a prediction output for a model input. In some examples, any of the logic, component(s), routines, and/or the like discussed herein may be implemented as a machine-learned model.

The machine-learned model may include one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

The embodiments of the present disclosure have been presented for purposes of illustration and description, but are not intended to be exhaustive or limited to the disclosure in the form disclosed. Many modifications and variations may be apparent to those of ordinary skill in the art without departing from the scope and spirit of the disclosure. The aspects of the disclosure herein were chosen and described to best explain the principles of the disclosure and the practical application thereof, and to enable others of ordinary skill in the art to understand the disclosure with various modifications as are suited to the particular use contemplated.

What is claimed is:

1. A computer-implemented method, comprising:
receiving input data; and
transforming the input data to generate output data that maintains relationships between individual data items of the input data, the output data including language data associated with the data items.

2. The computer-implemented method of claim 1, wherein the input data is structured input data.

3. The computer-implemented method of claim 1, wherein the input data is unstructured input data.

4. The computer-implemented method of claim 1, wherein the input data includes natural language text.

5. The computer-implemented method of claim 4, wherein the natural language text further includes image data.

6. The computer-implemented method of claim 1, wherein the input data comprises heterogeneous input data.

7. The computer-implemented method of claim 1, wherein transforming the input data comprises:
associating a label with one of the data items.

8. The computer-implemented method of claim 1, wherein transforming the input data comprises:
generating a single output data item for multiple ones of the data items;
generating multiple output data items for multiple ones of the data items; or
generating multiple output data items for a single one of the data items.

9. The computer-implemented method of claim 1, wherein the output data has syntactic relationships and a vocabulary associated therewith.

10. The computer-implemented method of claim 1, wherein the language data comprises a token associated with one of the data items, the token representing a category or a numeric relationship.

11. The computer-implemented method of claim 1, further comprising:
training a Natural Language Processing (NLP) model using the output data.

12. The computer-implemented method of claim 1, further comprising:
operating a Natural Language Processing (NLP) model to generate an inference responsive to a prompt comprising the output data.

13. The computer-implemented method of claim 1, further comprising:
updating a pre-trained model by performing an additional training operation using the output data.

14. A system, comprising:
one or more processors; and
one or more memories storing process-executable instructions that, when executed by the one or more processors, cause the one or more processors to perform operations comprising:
receiving input data; and
transforming the input data to generate output data that maintains relationships between individual data items of the input data, the output data including language data associated with the data items.

15. The system of claim 14, wherein transforming the input data comprises:
generating a single output data item for multiple ones of the data items;
generating multiple output data items for multiple ones of the data items; or
generating multiple output data items for a single one of the data items.

16. The system of claim 14, wherein the output data has syntactic relationships and a vocabulary associated therewith.

17. The system of claim 14, wherein the language data comprises a token associated with one of the data items, the token representing a category or a numeric relationship.

18. The system of claim 14, wherein the operations further comprise:
training a Natural Language Processing (NLP) model using the output data.

19. The system of claim 14, wherein the operations further comprise:
operating a Natural Language Processing (NLP) model to generate an inference responsive to a prompt comprising the output data.

20. One or more non-transitory computer-readable media storing processor-executable instructions that, when executed by one or more processors, cause the one or more processors to perform operations comprising:
receiving input data; and
transforming the input data to generate output data that maintains relationships between individual data items of the input data, the output data including language data associated with the data items.
